(19) United States
(12) Patent Application Publication
(10) Pub. No.: US 2022/0360958 A1
(43) Pub. Date: Nov. 10, 2022

(54) INTELLIGENT SERVICE COMPOSITION AND ORCHESTRATION USING AN ENHANCED END-TO-END SERVICE-BASED ARCHITECTURE

(71) Applicant: AT&T Intellectual Property I, L.P., Atlanta, GA (US)

(72) Inventors: Zhi Cui, Sugar Hill, GA (US); Paul Edward Smith, Jr., Heath, TX (US); David Kinsey, Carnation, WA (US)

(73) Assignee: AT&T Intellectual Property I, L.P., Atlanta, GA (US)

(21) Appl. No.: 17/314,112

(22) Filed: May 7, 2021

(51) Int. Cl. H04W 4/50; H04L 29/08

(52) U.S. Cl. CPC H04W 4/50; H04L 67/16

(57) ABSTRACT

Aspects of the subject disclosure may include, for example, obtaining information regarding a plurality of network resources available in an access network, wherein the plurality of network resources is abstracted as a plurality of universal resource ports, wherein the information identifies, for each network resource, a respective universal resource port, and wherein the information identifies capabilities of the plurality of network resources; receiving, from an external system, a request for a service to be provided for a UE; identifying a first set of universal resource ports based on the information and the request, wherein the first set of universal resource ports corresponds to a first set of network resources that have particular capabilities associated with the service; and causing a controller to define a route, that includes the first set of universal resource ports, to orchestrate provisioning and delivery of the service for the UE. Other embodiments are disclosed.

### FIELD OF THE DISCLOSURE

The subject disclosure relates to intelligent service composition and orchestration using an enhanced, end-to-end service-based architecture of a network system.

### BACKGROUND

Network providers and operators have gradually modernized communications networks in recent years to adapt to technological advances and growing data consumption needs. Many communications networks now operate based on software-defined networking (SDN) concepts, network function virtualization (NFV) concepts, and/or network function disaggregation (NFD) concepts.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within, or operatively overlaid upon, the communications network of FIG. 1 in accordance with various aspects described herein.

FIG. 2B is a block diagram illustrating an example, non-limiting embodiment of the system of FIG. 2A, in accordance with various aspects described herein.

FIG. 2C depicts an illustrative embodiment of a method in accordance with various aspects described herein.

FIG. 2D depicts an illustrative embodiment of a method in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The implementation of core networks, such as the 5G core, for example, has evolved into a service-based architecture (SBA) that facilitates (e.g., in the control plane) providing of communications services in a modular fashion. While network providers and operators have modernized the core network, current physical or virtual network models (e.g., even those based on SDN) still operate within the paradigm of traditional network services—i.e., where the architectural implementation and use of the radio access network (RAN) and/or wireline network, have generally remained unchanged. In particular, service layer connections involving RAN components, such as nodes (e.g., eNodeBs, gNodeBs, Gigabyte Passive Optical Networks (GPON) nodes, or the like), links therebetween, and point-to-point interfaces, continue to be symmetric—that is, where phone-to-phone services, Ethernet services, Layer 2 (L2) Ethernet services, L2 VPN services, Layer 3 (L3) VPN services, etc. require the same (or the same types of) end devices/points, and thus building out, or composition of, such services remains complex and inflexible. Existing architectures restrict service delivery to within a single mobility/access network, RAN, and core, and also provide limited support for future network disaggregation efforts and any-to-any (or end-to-end or end-to-multiple-end) services, such as any-to-any communications services (e.g., phone-to-cloud services, etc.) or the like.

The subject disclosure describes, among other things, illustrative embodiments of an enhanced, end-to-end service-based architecture for a network system that is capable of facilitating dynamic, intelligent composition of functions and interfaces for supporting any-to-any services and networking. In exemplary embodiments, a service-based architecture design or configuration is extended to an access network (e.g., a RAN) of the network system, thereby providing a “bus”-like architecture for the access network that enables dynamic connectivity between resources/functions in the access network. In various embodiments, resources in the access network, such as physical resources (e.g., base stations, satellites, optical network systems/components, and/or the like) and/or logical resources (e.g., hardware/software implementations of various functions, such as those relating to voice, video, security, and/or the like), may be abstracted (e.g., defined in one or more descriptor objects) as universal resource ports—e.g., similar to plug-ins with a universal interface, such as the Universal Serial Bus (USB), which allows a network service assembler to selectively leverage access network resources, and “chain” or “stitch” physical or virtual ports, to provide or establish end-to-end services. In one or more embodiments, access network resources (e.g., all access network resources) may be abstracted from Layer 2 (e.g., Ethernet or data link layer) and above in the Open Systems Interconnection (OSI) Model (e.g., software-based Layer 2 and above).

Embodiments of the enhanced, end-to-end service-based architecture, described herein, leverage network abstraction to advance beyond traditionally, restrictive symmetric forms of service delivery. The enhanced, end-to-end service-based architecture enables a network provider or operator to more simply and efficiently model a network service (or information) delivery system with service layer connections involving RAN components that need not be symmetric—e.g., that supports any-to-any connections/services with any-to-any networking (e.g., voice call to multiple services in a cloud platform, including, e.g., Internet-of-Things (IoT) devices or the like)—while hiding the underlying complexities of the network system. Services (e.g., 5G, 6G, or higher generation wireless access network services) can also be delivered for users in real-time based on service needs as well as operating conditions of end devices.

Exemplary embodiments described herein also provide a network service assembler—e.g., an intelligent agent—that is capable of leveraging the enhanced end-to-end service-based architecture to create, for a requested service, a service composition that meets requirements and performance objectives of the service and that is optimized for operational cost. In various embodiments, the intelligent agent may be implemented in a service design and orchestration (SDO) system of a software-defined network (SDN) of the network system, and may coordinate with an SDN controller and a detection and service healing (DSH) element in the SDN to facilitate design and orchestration of end-to-end services. In one or more embodiments, the SDN controller may be capable of facilitating service connections that enable data communications to flow between virtual device(s) and virtual cloud(s). In exemplary embodiments, the SDO system may receive service requests and process the service requests to determine a service composition description. In various embodiments, the SDO system may identify/select appropriate universal resource ports corresponding to physical/logical resources of the access network that are capable of supporting the requested service, and may request or instruct the SDN controller to establish routing to enable service flow between the identified/selected universal resource ports. In this way, the SDN controller may provide dynamic, intelligent composition of functions and interfaces for any-to-any networking/service orchestration and delivery. In one or more embodiments, the intelligent agent may obtain data regarding capabilities, bandwidth/loading capacity, performance metrics/values, and/or the like relating to the underlying physical/logical resources corresponding to the universal resource ports, and utilize this data in conjunction with (e.g., compare the data with) requirements (e.g., a service level agreement (SLA) or the like) specified in the service composition description to assemble a service flow that meets the requirements.

Dynamic, intelligent composition of functions and interfaces for any-to-any networking/service orchestration and delivery, by leveraging embodiments of the enhanced end-to-end service-based architecture, provides reliable, optimal, and cost-effective (e.g., lowest operational cost) service delivery, which improves overall user experience and network performance.

One or more aspects of the subject disclosure include a device, comprising a processing system including a processor, and a memory that stores executable instructions that, when executed by the processing system, facilitate performance of operations. The operations can include obtaining information regarding a plurality of network resources available in an access network, wherein the plurality of network resources is abstracted as a plurality of universal resource ports, wherein the information identifies, for each network resource of the plurality of network resources, a respective universal resource port of the plurality of universal resource ports, and wherein the information identifies capabilities of the plurality of network resources. Further, the operations can include receiving, from an external system, a request for a service to be provided for a user equipment, and responsive to the receiving the request, identifying a first set of universal resource ports of the plurality of universal resource ports based on the information and the request, wherein the first set of universal resource ports corresponds to a first set of network resources of the plurality of network resources that have particular capabilities associated with the service. Further, the operations can include causing a controller to define a route, that includes the first set of universal resource ports, to orchestrate provisioning and delivery of the service for the user equipment.

One or more aspects of the subject disclosure include a non-transitory machine-readable medium, comprising executable instructions that, when executed by a processing system including a processor, facilitate performance of operations. The operations can include receiving, from a service design and orchestration (SDO) system, a request to chain a set of universal resource ports, wherein the request is based on the SDO system detecting an order for a service and identifying the set of universal resource ports in accordance with requirements identified in the order, wherein the set of universal resource ports is an abstraction of a corresponding set of network resources in an access network, and wherein the access network is implemented in a service-based architecture configured to provide end-to-end services. Further, the operations can include, responsive to the receiving the request to chain the set of universal resource ports, defining a service path from the access network, through a core network, and to an endpoint server device, wherein the service path includes the set of universal resource ports.

One or more aspects of the subject disclosure include a method. The method can include monitoring, by a processing system including a processor, and based on fault definitions provided by a service design and orchestration (SDO) system, a performance of a first set of network resources of a plurality of network resources included in a radio access network (RAN), where the first set of network resources is included in a service composition and is selected to provide an end-to-end service, wherein the monitoring comprises obtaining data using a network resource abstraction layer in which the plurality of network resources is abstracted as a plurality of universal resource ports, and wherein the first set of network resources corresponds to a first set of universal resource ports of the plurality of universal resource ports. Further, the method can include, based on detecting, in accordance with the monitoring, a fault in a first network resource of the first set of network resources, submitting, by the processing system, a request to the SDO system to repair the service composition, wherein the request causes the SDO system to identify a second set of universal resource ports corresponding to a second set of network resources that is capable of providing the end-to-end service, and wherein the second set of network resources excludes the first network resource.

Other embodiments are described in the subject disclosure.

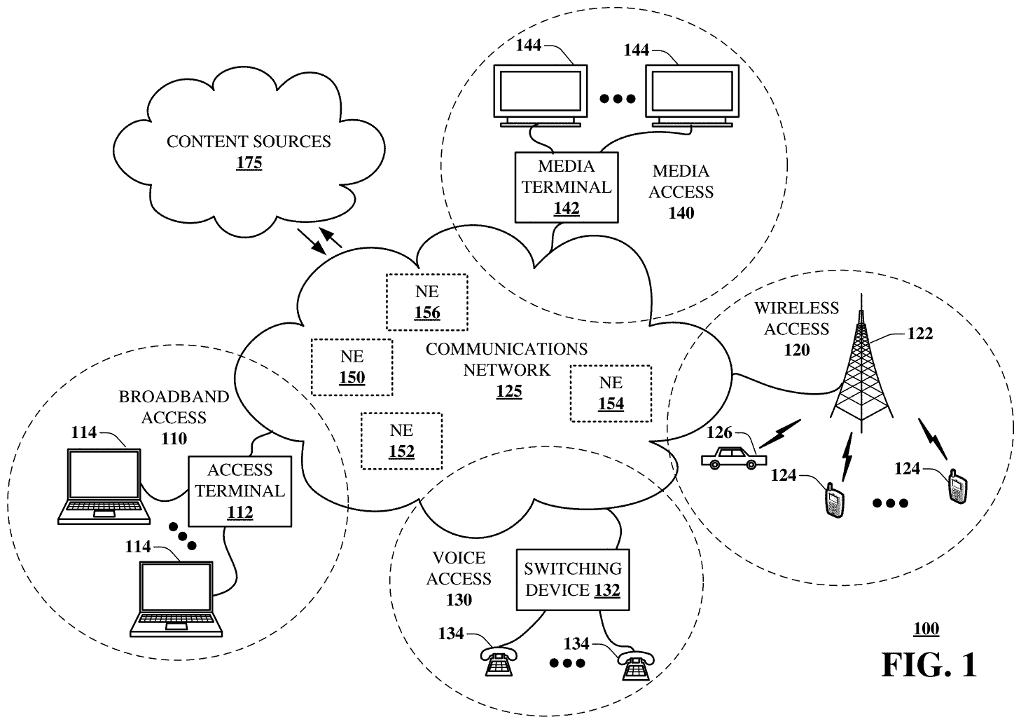

Referring now to FIG. 1, a block diagram is shown illustrating an example, non-limiting embodiment of a system 100 in accordance with various aspects described herein. For example, system 100 can include, provide, or be used with, in whole or in part, an enhanced, end-to-end service-based architecture of a network system in which access network resources are abstracted as universal resource ports. As another example, system 100 can facilitate dynamic, intelligent composition of functions and interfaces for any-to-any networking/service orchestration and delivery using an enhanced end-to-end service-based architecture of a network system in which access network resources are abstracted as universal resource ports. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

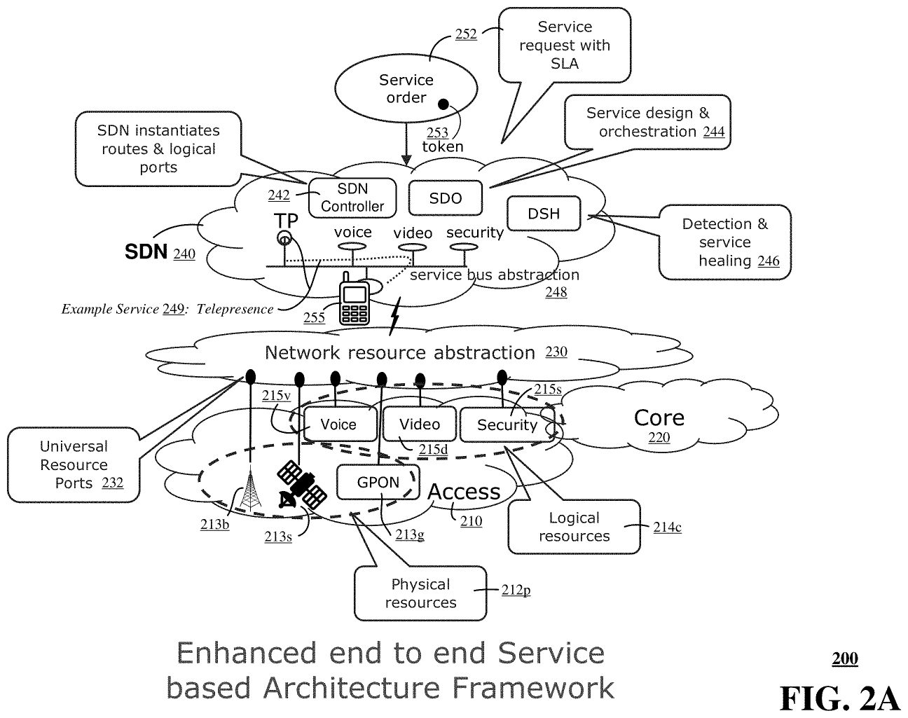

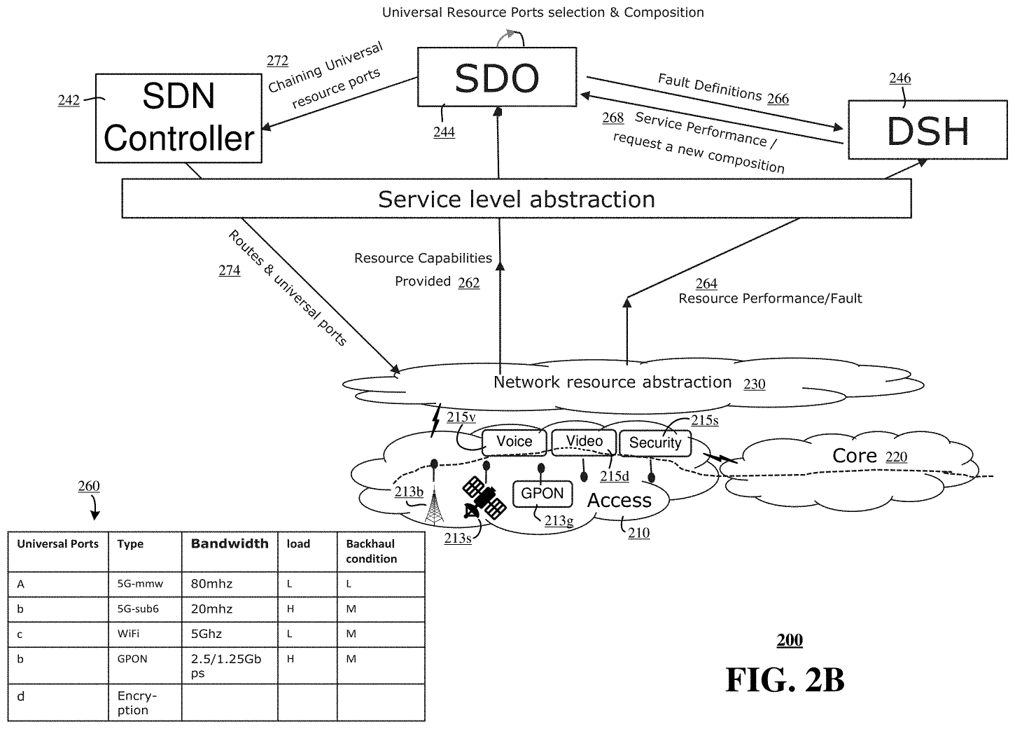

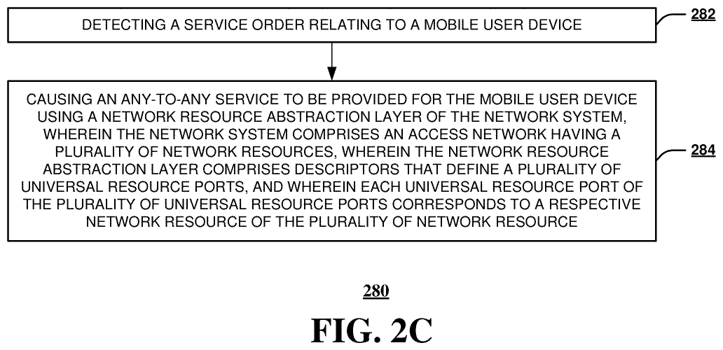

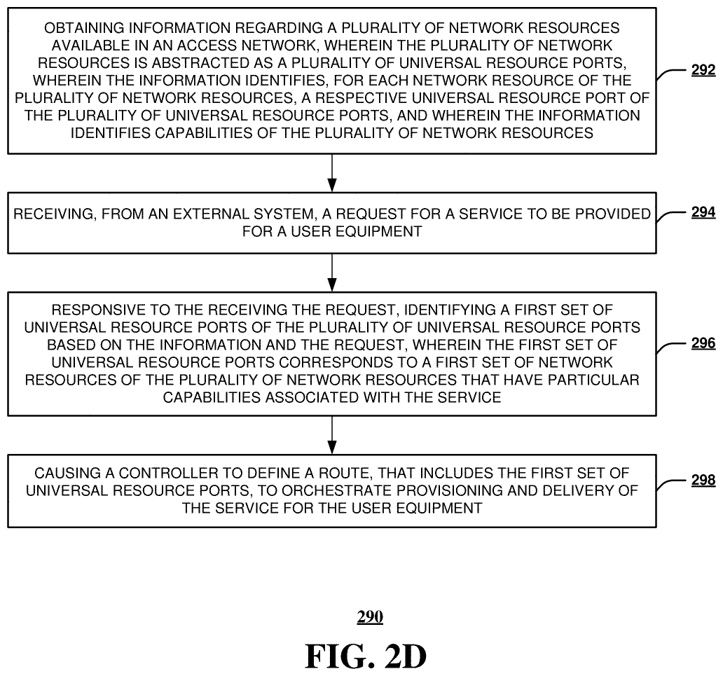

FIG. 2A is a block diagram illustrating an example, non-limiting embodiment of an enhanced end-to-end service-based architecture of a system 200 (e.g., a network system 200) functioning within, or operatively overlaid upon, the communications network 100 of FIG. 1 in accordance with various aspects described herein.

As shown in FIG. 2A, the system 200 may include an access network 210 (e.g., a wireless radio access network (RAN), a Wi-Fi network, and/or a wireline network) and a core network 220. The access network 210 may include network resources, such as one or more physical resources (or network nodes) 212p and/or one or more logical resources 214c. As depicted in FIG. 2A, the physical resources 212p can include base station(s) 213b (e.g., one or more eNodeBs, one or more gNodeBs, or the like), one or more satellites 213s and/or unmanned aerial vehicles (UAVs), and one or more Gigabyte Passive Optical Networks (GPONs) 213g and/or related components (e.g., Optical Line Terminal(s) (OLT), Optical Network Unit(s) (ONU), etc.). A base station 213b may employ any suitable radio access technology (RAT), such as LTE, 5G, 6G, or any higher generation radio access technology. As shown in FIG. 2A, the logical resources 214c can include a voice service system 215v (e.g., a hardware and/or software implementation of voice-related functions), a video service system 215d (e.g., a hardware and/or software implementation of video-related functions, such as coder-decoder or compression-decompression (CODEC) components or the like), and a security service system 215s (e.g., a hardware and/or software implementation of security-related functions). In various embodiments, the access network 210 can include any number/types of physical/logical resources and various types of heterogeneous cell configurations with various quantities of cells and/or types of cells.

In various embodiments, the physical resources 212p and/or the logical resources 214c may be in communication with the core network 220 via a backhaul network (not shown). The core network 220 can be in further communication with one or more other networks (e.g., one or more content delivery networks (CDNs)), one or more services, and/or one or more devices.

The core network 220 can include various network devices and/or systems that provide a variety of functions. Examples of functions provided by, or included, in the core network 220 include an access mobility and management function (AMF) configured to facilitate mobility management in a control plane of the network system 200, a User Plane Function (UPF) configured to provide access to a data network, such as a packet data network (PDN), in a user (or data) plane of the network system 200, a Unified Data Management (UDM) function, a Session Management Function (SMF), a Policy Control Function (PCF), and/or the like. In various embodiments, the core network 220 may include one or more devices implementing other functions, such as a master user database server device for network access management, a PDN gateway server device for facilitating access to a PDN, and/or the like.

The system 200 can provide services to various types of user equipment (UE), such as UE 255. Examples of UE 255 include mobile devices 124, display and television devices, home and business networks, IoT devices, video and audio devices, and so on. UE 255 can be equipped with one or more transmitter (Tx) devices and/or one or more receiver (Rx) devices configured to communicate with, and utilize network resources of, the system 200.

In exemplary embodiments, the access network resource abstraction layer 230 may provide abstractions of the physical resources 212p and the logical resources 214c. In various embodiments, the physical resources 212p and the logical resources 214c may be abstracted and be accessible via universal resource ports 232. In one or more embodiments, the abstractions may be from Layer 2 (e.g., Ethernet or data link layer) and above in the Open Systems Interconnection (OSI) Model. Such abstractions allow the physical resources 212p and the logical resources 214c to be presented to a software-defined network (SDN) 240 as universal resources (e.g., similar to plug-ins with a universal interface, such as the Universal Serial Bus (USB)), which can enable the SDN 240 to access, and leverage, the universal resources to provide, or support, end-to-end services. In this way, for example, access, control, and usage of the physical resources 212p and the logical resources 214c of the access network 210 may be all based on software from Layer 2 and above.

In various embodiments, each universal resource port 232 may correspond to a respective physical resource 212p or logical resource 214c. The physical resources 212p and the logical resources 214c may be abstracted to descriptor object(s) that identify the physical resources 212p and the logical resources 214c, the corresponding universal resource ports 232, and data associated with the physical resources 212p and the logical resources 214c. In one or more embodiments, the network resource abstraction layer 230 may include a descriptor object for each physical resource 212p or logical resource 214c, the corresponding universal resource port 232, and the corresponding data, or may include a descriptor object (e.g., a single descriptor object) for all available or accessible physical/logical resources 212p/214c, corresponding universal resource ports 232, and associated data.

The data, for a universal resource, may include, for example, information regarding a communication protocol associated with the universal resource, information regarding capabilities of the universal resource, information regarding services provided by the universal resource, information regarding an operating status of the universal resource, information regarding operational limits associated with the universal resource, and/or the like.

Providing network resource abstraction(s), as described herein, enables a system, such as a service design and orchestration (SDO) system to (e.g., optimally) select, and connect, cost-effective features or resources (e.g., video-related service(s) or resource(s), virtual private networking-related service(s) or resource(s), etc.) to meet the service needs of consumers or enterprises.

In various embodiments, the network system 200 may be implemented using SDN technology. As shown in FIG. 2A, the SDN 240 may include an SDN controller 242, an SDO system 244, and a detection and service healing (DSH) element 246.

SDN 240 can allow the network system 100 to separate control plane operations from data plane operations, and can enable layer abstraction for separating service and network functions or elements from physical network functions or elements. In one or more embodiments, the SDN controller 242 can coordinate networking and provisioning of applications and/or services. The SDN controller 242 can manage transport functions for various layers within the network system 200, and can access application functions for layers above the network system 200. The SDN controller 242 can provide a platform for network services, network control of service instantiation and management, as well as a programmable environment for resource and traffic management. The SDN controller 242 can also permit a combination of real-time data from the service and network elements with real-time, or near real-time, control of a forwarding plane. In various embodiments, the SDN controller 242 can enable flow set up in real-time, network programmability, extensibility, standard interfaces, and/or multi-vendor support. In one or more embodiments, interactions between layers of the network system 200 can be based upon policies, which can determine optimum configuration and rapid adaptation of the network system 200 to changing state and changing customer requirements—e.g., predicted demand, addition of new users, spikes in traffic, planned and unplanned network outages, adding new services, and/or maintenance. In various embodiments, the SDN controller 242 may be configured to instantiate routes and logical ports, as described in more detail below.

As shown in FIG. 2A, the SDN 240 may provide a service bus abstraction 248 that enables determining of available access network resources and/or services provided by such access network resources, and identifying of appropriate access network resources that can be utilized to satisfy requirement(s) of requested services. In exemplary embodiments, the SDN 240 (e.g., the SDO system 244) may receive and process a service request 252 by decomposing or analyzing the service request 252 to identify the type of service that is requested, information regarding an end device (e.g., a UE 255 or the like) for which the service is to be facilitated, requirements of the service, and/or the like. For instance, in a case where the SDN 240 (e.g., the SDO system 244) receives a request for a telepresence service to be facilitated, the SDN 240 (e.g., the SDO system 244) may determine that video-related and voice-related resources are needed to facilitate the telepresence service, determine, based on the access network resource abstraction 230, that the voice service system 215v and the video service system 215d are available and accessible (e.g., via respective universal resource ports 232), and cause the service bus abstraction 248 to connect (or stitch) (249) instances of the voice service system 215v and the video service system 215d to provide the telepresence service.

In various embodiments, the SDN 240 may be communicatively coupled with a backend system (e.g., a backend customer service portal or the like) via which external systems (e.g., third-party server devices, such as gaming servers, video conferencing servers, etc.) may submit service request(s) 252 associated with end users or devices (e.g., UE 255).

In various embodiments, a service request 252 may include a token 253 (e.g., a unique identifier or the like) that identifies a desired service, customer account information regarding an end user or an end user device (e.g., UE 255) associated with the end user, service requirements and/or a service level agreement (SLA) associated with the end user, and/or the like. In one or more embodiments, the SDN 240 may utilize the token 253 to set policies for the end user device and provision the core network 220 with data regarding the end user device, such that when the end user device attaches to the access network 210, the end user device has the appropriate rights and/or permissions to use the provisioned service. Based on the provisioning, the core network 220 may provide the end user device with information regarding service point connections (e.g., to one or more UPFs or the like in the core network 220's infrastructure system architecture).

As an example, an external gaming server may, based upon detecting a user's desire to engage in mobile gaming using a UE 255, submit a corresponding service (or provisioning) request 252 that includes a token 253 containing information regarding the UE 255. Continuing the example, the SDN 240 (e.g., the SDO system 244) may receive and analyze the service request 252, and based on result(s) of the analysis (e.g., the determined type of service needed, requirement(s) of the service, and/or the like), identify select universal resources of the access network 210 that can be used to provide the service for the user. Further continuing the example, a corresponding app service may be created using the selected universal resources, and connected to a data plane (e.g., a UPF or the like) to provision the UE 255, such that, when the UE 255 begins facilitating the mobile gaming, the service is provided to the UE 255 (e.g., as a service endpoint) via the selected universal resources and the data plane.

FIG. 2B is a block diagram illustrating an example, non-limiting embodiment of the system 200 of FIG. 2A, in accordance with various aspects described herein. As briefly described above, the SDO system 244 may be configured to receive service requests/orders 252. A service request 252 may include application objects and/or requests for particular services or functions, requests for generation of services and/or requests for particular functionality, queries, combinations thereof, or the like, information identifying requirements of the service (e.g., an SLA or the like), etc. The SDO system 244 can analyze a service request to determine functions and/or network data flows that are needed to facilitate delivery of the requested service. In various embodiments, the SDO system 244 may select/define a directed graph and/or an associated model that identifies features of the requested service. The SDO system 244 may generate model(s) for the requested service in a programming language or format, such as Extensible Markup Language (XML), Yang models, other types of files, combinations thereof, or the like.

In various embodiments, the SDO system 244 (e.g., a network service assembler or intelligent agent of the SDO system 244) may determine, using the descriptor objects provided by the access network abstraction layer 230, a model of the available network resources, identify and select universal resource ports 232 that correspond to the network resources that are needed to support the service as indicated in the abovementioned service model, and orchestrate connections of the selected universal resource ports 232 (or associated services) to derive a low-cost (e.g., optimal) service path. In the telepresence example described above, the SDO system 244 may, based upon a service model determined from a service request, identify the network resources—e.g., video-related resources, voice-related resources, etc.—that are needed to support the telepresence service, and select, using a model of the available network resources in the access network 210, a universal resource port 232 that corresponds to the voice service system 215v and a universal resource port 232 that corresponds to the video service system 215d to derive an optimal service path.

In one or more embodiments, the SDO system 244 may determine, and use, information regarding associated user priorities, extant network resource loadings, and/or the like to compose the requested service. In various embodiments, the SDO system 244 may obtain (262) and/or maintain information regarding abstracted network resources, and utilize the information to identify and/or select available and accessible universal resource ports 232 for a requested service. In one or more embodiments, the information may be represented in a descriptor table 260 that defines the universal resource ports 232 and that identifies various data associated with the network resources (e.g., each network resource), such as a type of the network resource, capabilities of the network resource (e.g., bandwidth, frequency, or the like), capacity or load information, status or condition (e.g., backhaul condition or the like), etc.

In exemplary embodiments, the SDO system 244 may request or instruct (272) the SDN controller 242 to derive (or stitch together) a service path for a requested service. In various embodiments, the SDN controller 242 may (e.g., as demanded by the SDO system 244) configure policies associated with an endpoint device (e.g., a UE associated with a user or enterprise), and instantiate (274) a route (or connection) between the selected universal resource ports 232—e.g., by chaining logical ports—to establish the networking between the selected universal resource ports 232 (e.g., the corresponding, underlying network resources) so as to configure, otherwise set up, the connections for service delivery. For example, the route may run between the selected universal resource ports 232, the core network 220, and an endpoint access server associated with the requested service. In this way, the SDN controller 242 may provide dynamic, intelligent composition of service functions and associated interfaces to derive a service instance for a requested service. In one or more embodiments, the SDN controller 242 may also be capable of constructing instances of functions based on requested service needs. For example, in a case where a requested service includes a security attribute, the SDN controller 242 may construct a firewall (e.g., a dedicated or shared instance) for the requested service.

With access to the network resource abstractions, and based on requested service definition(s), the SDO system 244 can, therefore, design and orchestrate service delivery for end consumers or enterprises using the most cost-effective network resources.

In various embodiments, the DSH element 246 may monitor the network resources (e.g., for performance, for faults, for Quality of Service (QoS) purposes (e.g., relating to latency, transmission speed, transmission frequency, routing, uplink/downlink, quality of service class identifier (QCI), etc.), and/or the like) and provide reports on the network resources (e.g., operational status/health reports or the like) to the SDO system 244 to facilitate service design, composition, and orchestration. As depicted in FIG. 2B, the DSH element 246 may obtain (e.g., based on the monitoring) information regarding network resource performance and/or faults (264) from the access network resource abstraction layer 230. As shown by reference number 266, the DSH 246 may obtain fault definitions provided by the SDO system 244, which may identify threshold(s) associated with certain data regarding the network resource(s) that the DSH element 246 is to monitor and report on. As an example, a fault definition may include a threshold loading capacity for a network resource, such as a 5G mmW access point. In some embodiments, the DSH element 246 may, based on monitoring data regarding a particular network resource, determine whether a parameter of the particular network resource satisfies a threshold (e.g., exceeds the threshold). In a case where the DSH element 246 determines that the parameter satisfies the threshold, the DSH element 246 may provide a corresponding report to the SDO system 244, which the SDO system 244 may utilize to determine whether the particular network resource should be included in a set of network resources for supporting a requested service. In a case where a service path has already been established by the SDO system 244 and/or the SDN controller 242, and where the DSH element 246 determines that a certain network resource, included in the service path, satisfies a certain threshold (which may, for example, relate to an object or requirement of the service), the DSH element 246 may provide a report on performance of the service associated with the certain network resource and/or submit (268) a request to the SDO system 244 to repair the service composition or generate a new service composition. In such cases, the SDO system 244 may recalculate, or redetermine, a service composition that excludes the non-performant network resource, and cause an adjusted service path to be instantiated. For example, in a case where the SDO system 244 determines, based on a report provided by the DSH element 246 that a base station (e.g., base station 213b) has failed, is overloaded, or is underperforming, and where the SDO system 244 identifies an available Wi-Fi access point that a UE (e.g., the UE 255) associated with the service is within communicable range of, the SDO system 244 may reinstantiate the service path to exclude the base station and include the Wi-Fi access point. In various embodiments, the SDO system 244 may exclude or replace other network resource(s) in a re-determined service composition (e.g., even those network resources that might not be underperforming) if the SDO system 244 determines that excluding a non-performant network resource might introduce system latencies, breach rules between the some or all of the network resources in the current service composition, or the like.

By providing analytic outputs or the like to the SDO system 244, the DSH element 246 enables the SDO system 244 to dynamically adjust service paths, and thereby facilitates ongoing, proactive self-management of a service, which improves overall end user experience. Performing load balancing and maximizing use of an entirety of the access network 210 as part of such self-management can also improve overall network performance. Furthermore, by providing an enhanced, end-to-end service-based architecture, as described herein, access network resources may be abstracted as individual universal resources, and made accessible via corresponding universal resource ports that can be connected or stitched (e.g., based on requested service needs) to seamlessly provide any-to-any services for users.

It is to be appreciated and understood that embodiments of the enhanced end-to-end service-based architecture, and more particularly, abstractions of devices/components as universal resource ports in Layer 2 and above, can be applied to other parts of a network system, such as a transport network.

It is also to be appreciated and understood that the quantity and arrangement of access networks, physical resources, logical resources, core networks, network resource abstractions, ports, software-defined networks, software-defined network components, and service bus abstractions shown in FIGS. 2A and 2B are provided as an example. In practice, there may be additional access networks, physical resources, logical resources, core networks, network resource abstractions, ports, software-defined networks, software-defined network components, and/or service bus abstractions, fewer access networks, physical resources, logical resources, core networks, network resource abstractions, ports, software-defined networks, software-defined network components, and/or service bus abstractions, different access networks, physical resources, logical resources, core networks, network resource abstractions, ports, software-defined networks, software-defined network components, and/or service bus abstractions, or differently arranged access networks, physical resources, logical resources, core networks, network resource abstractions, ports, software-defined networks, software-defined network components, and/or service bus abstractions than those shown in FIGS. 2A and 2B. For example, the system 200 can include more or fewer access networks, physical resources, logical resources, core networks, network resource abstractions, ports, software-defined networks, software-defined network components, and/or service bus abstractions, etc. In practice, therefore, there can be hundreds, thousands, millions, billions, etc. of such access networks, physical resources, logical resources, core networks, network resource abstractions, ports, software-defined networks, software-defined network components, and/or service bus abstractions. In this way, example system 200 can coordinate, or operate in conjunction with, a set of access networks, physical resources, logical resources, core networks, network resource abstractions, ports, software-defined networks, software-defined network components, and/or service bus abstractions and/or operate on data sets that cannot be managed manually or objectively by a human actor. Furthermore, two or more access networks, physical resources, logical resources, core networks, network resource abstractions, ports, software-defined networks, software-defined network components, and/or service bus abstractions shown in FIGS. 2A and 2B may be implemented within a single access network, physical resource, logical resource, core network, network resource abstraction, port, software-defined network, software-defined network component, or service bus abstraction, or a single access network, physical resource, logical resource, core network, network resource abstraction, port, software-defined network, software-defined network component, or service bus abstraction shown in FIGS. 2A and 2B may be implemented as multiple access networks, physical resources, logical resources, core networks, network resource abstractions, ports, software-defined networks, software-defined network components, and/or service bus abstractions. Additionally, or alternatively, a set of access networks, physical resources, logical resources, core networks, network resource abstractions, ports, software-defined networks, software-defined network components, and/or service bus abstractions of the system 200 may perform one or more functions described as being performed by another set of access networks, physical resources, logical resources, core networks, network resource abstractions, ports, software-defined networks, software-defined network components, and/or service bus abstractions of the system 200.

FIG. 2C depicts an illustrative embodiment of a method 280 in accordance with various aspects described herein. In some embodiments, one or more process blocks of FIG. 2C can be performed by a network system, such as the network system 200 (e.g., the SDN 240 of the network system 200).

At 282, the method can include detecting a service order relating to a mobile user device, and at 284, the method can include causing an any-to-any service to be provided for the mobile user device using a network resource abstraction layer of the network system, wherein the network system comprises an access network having a plurality of network resources, wherein the network resource abstraction layer comprises descriptors that define a plurality of universal resource ports, and wherein each universal resource port of the plurality of universal resource ports corresponds to a respective network resource of the plurality of network resource. For example, the network system 200 (e.g., the SDN 240) can detect a service order relating to a mobile user device and cause an any-to-any service to be provided for the mobile user device using a network resource abstraction layer of the network system 200 in a manner similar to that described above with respect to the system 200 of FIG. 2A, wherein the network system comprises an access network having a plurality of network resources, wherein the network resource abstraction layer comprises descriptors that define a plurality of universal resource ports, and wherein each universal resource port of the plurality of universal resource ports corresponds to a respective network resource of the plurality of network resource.

In various embodiments, the network system may be implemented in an enhanced, end-to-end service-based architecture that enables a network provider or operator to more simply and efficiently model a network service (or information) delivery system with service layer connections involving RAN components that need not be symmetric—e.g., that supports any-to-any connections/services with any-to-any networking (e.g., voice call to multiple services in a cloud platform, including, e.g., Internet-of-Things (IoT) devices or the like).

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2D depicts an illustrative embodiment of a method 290 in accordance with various aspects described herein. In some embodiments, one or more process blocks of FIG. 2D can be performed by an SDO system, such as the SDO system 244. In some embodiments, one or more process blocks of FIG. 2D may be performed by another device or a group of devices separate from or including the SDO system 244, such as the SDN 240, the SDN controller 242, the DSH element 246, the access network 210, the core network 220, and/or network abstraction layer 230.

At 292, the method can include obtaining information regarding a plurality of network resources available in an access network, wherein the plurality of network resources is abstracted as a plurality of universal resource ports, wherein the information identifies, for each network resource of the plurality of network resources, a respective universal resource port of the plurality of universal resource ports, and wherein the information identifies capabilities of the plurality of network resources. For example, the SDO system 244 can obtain information regarding a plurality of network resources available in an access network in a manner similar to that described above with respect to the system 200 of FIGS. 2A and 2B, where the plurality of network resources is abstracted as a plurality of universal resource ports, where the information identifies, for each network resource of the plurality of network resources, a respective universal resource port of the plurality of universal resource ports, and where the information identifies capabilities of the plurality of network resources.

At 294, the method can include receiving, from an external system, a request for a service to be provided for a user equipment. For example, the SDO system 244 can receive, from an external system, a request for a service to be provided for a user equipment in a manner similar to that described above with respect to the system 200 of FIGS. 2A and 2B.

At 296, the method can include, responsive to the receiving the request, identifying a first set of universal resource ports of the plurality of universal resource ports based on the information and the request, wherein the first set of universal resource ports corresponds to a first set of network resources of the plurality of network resources that have particular capabilities associated with the service. For example, the SDO system 244 can, responsive to the receiving the request, identify a first set of universal resource ports of the plurality of universal resource ports based on the information and the request in a manner similar to that described above with respect to the system 200 of FIGS. 2A and 2B, where the first set of universal resource ports corresponds to a first set of network resources of the plurality of network resources that have particular capabilities associated with the service.

At 298, the method can include causing a controller to define a route, that includes the first set of universal resource ports, to orchestrate provisioning and delivery of the service for the user equipment. For example, the SDO system 244 can cause a controller to define a route, that includes the first set of universal resource ports, to orchestrate provisioning and delivery of the service for the user equipment in a manner similar to that described above with respect to the system 200 of FIGS. 2A and 2B.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

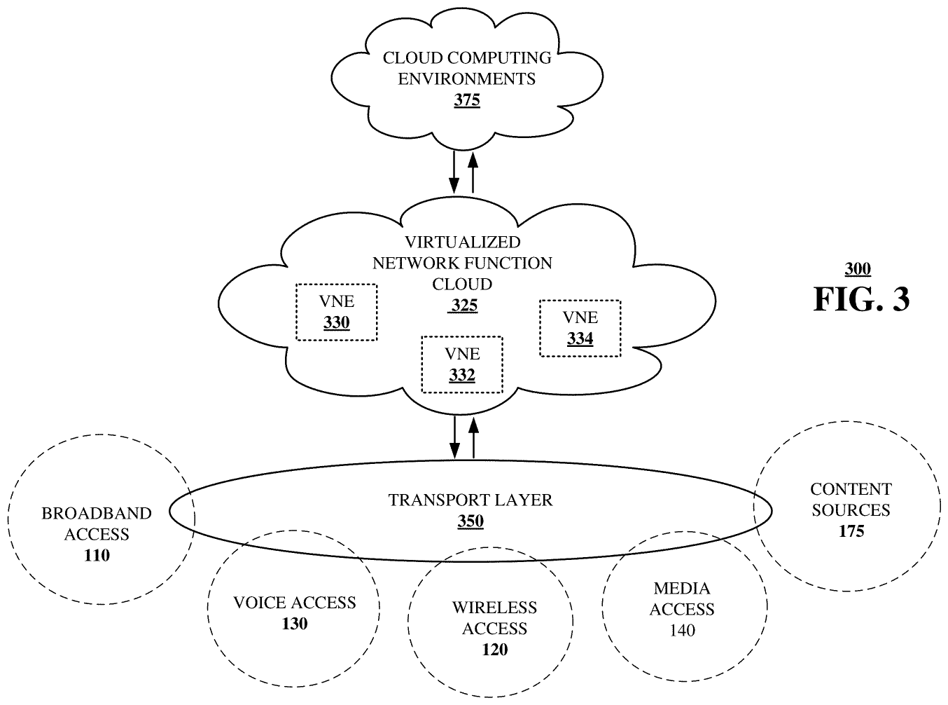

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of system 100, the subsystems and functions of system 200, and methods 280 and 290 presented in FIGS. 1 and 2A-2D. For example, virtualized communications network 300 can include, provide, or be used with, in whole or in part, an enhanced, end-to-end service-based architecture of a network system in which access network resources are abstracted as universal resource ports. As another example, virtualized communications network 300 can facilitate dynamic, intelligent composition of functions and interfaces for any-to-any networking/service orchestration and delivery using an enhanced end-to-end service-based architecture of a network system in which access network resources are abstracted as universal resource ports.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

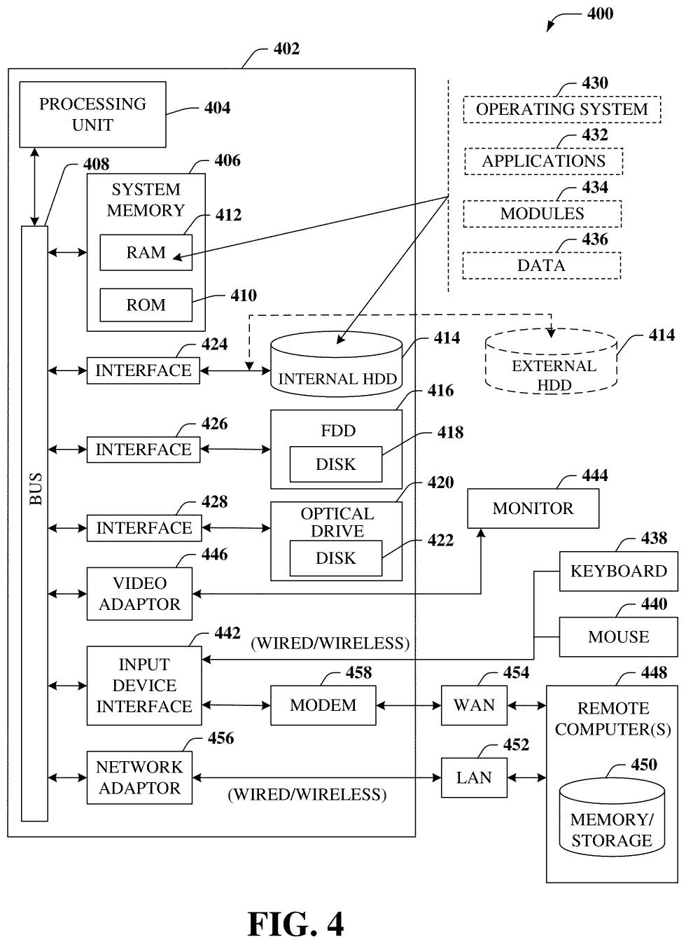

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can include, provide, or be used with, in whole or in part, an enhanced, end-to-end service-based architecture of a network system in which access network resources are abstracted as universal resource ports. As another example, computing environment 400 can facilitate dynamic, intelligent composition of functions and interfaces for any-to-any networking/service orchestration and delivery using an enhanced end-to-end service-based architecture of a network system in which access network resources are abstracted as universal resource ports.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

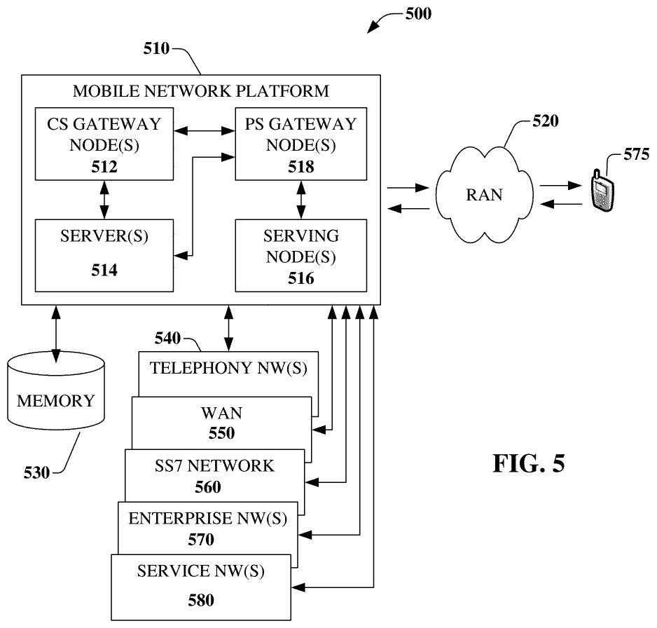

Turning now to FIG. 5, an embodiment 500 of a mobile network platform 510 is shown that is an example of network elements 150, 152, 154, 156, and/or VNEs 330, 332, 334, etc. For example, platform 510 can include, provide, or be used with, in whole or in part, an enhanced, end-to-end service-based architecture of a network system in which access network resources are abstracted as universal resource ports. As another example, platform 510 can facilitate dynamic, intelligent composition of functions and interfaces for any-to-any networking/service orchestration and delivery using an enhanced end-to-end service-based architecture of a network system in which access network resources are abstracted as universal resource ports. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

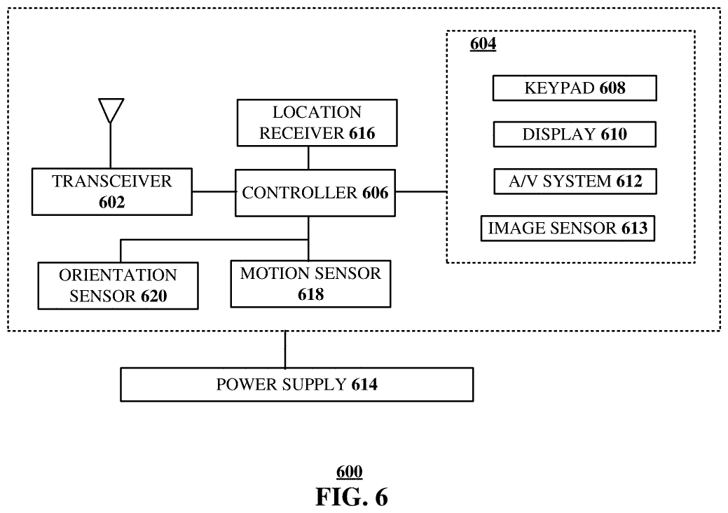

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can include, provide, or be used with, in whole or in part, an enhanced, end-to-end service-based architecture of a network system in which access network resources are abstracted as universal resource ports. As another example, computing device 600 can facilitate dynamic, intelligent composition of functions and interfaces for any-to-any networking/service orchestration and delivery using an enhanced end-to-end service-based architecture of a network system in which access network resources are abstracted as universal resource ports.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” “subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” “data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

1. A device, comprising:
a processing system including a processor; and
a memory that stores executable instructions that, when executed by the processing system, facilitate performance of operations, the operations comprising:
obtaining information regarding a plurality of network resources available in an access network, wherein the plurality of network resources is abstracted as a plurality of universal resource ports, wherein the information identifies, for each network resource of the plurality of network resources, a respective universal resource port of the plurality of universal resource ports, and wherein the information identifies capabilities of the plurality of network resources;
receiving, from an external system, a request for a service to be provided for a user equipment;
responsive to the receiving the request, identifying a first set of universal resource ports of the plurality of universal resource ports based on the information and the request, wherein the first set of universal resource ports corresponds to a first set of network resources of the plurality of network resources that have particular capabilities associated with the service; and
causing a controller to define a route, that includes the first set of universal resource ports, to orchestrate provisioning and delivery of the service for the user equipment.

2. The device of claim 1, wherein the processing system comprises a service design and orchestration (SDO) system.

3. The device of claim 1, wherein the service involves a video-related function, a voice-related function, a security-related function, or a combination thereof.

4. The device of claim 1, wherein the information is represented in a descriptor table that associates each universal resource port of the plurality of universal resource ports with capability information regarding a network resource of the plurality of network resources that corresponds to that universal resource port.

5. The device of claim 1, wherein the request comprises a token that includes identification information associated with the user equipment.

6. The device of claim 1, wherein the request comprises requirements for the service, and wherein the identifying the first set of universal resource ports comprises comparing the requirements and the capabilities of the plurality of network resources.

7. The device of claim 1, wherein the controller comprises a software-defined network (SDN) controller, and wherein the route comprises a service path between the first set of universal resource ports, a core network, and an endpoint server device.

8. The device of claim 1, wherein the operations further comprise providing fault definitions, associated with the first set of network resources, to a detection and service healing (DSH) element, and responsive to the providing the fault definitions, receiving, from the DSH element, fault information relating to the first set of network resources.

9. The device of claim 1, wherein the plurality of network resources comprises physical resources, logical resources, or a combination thereof.

10. The device of claim 1, wherein the plurality of network resources is abstracted in Layer 2.

11. A non-transitory machine-readable medium, comprising executable instructions that, when executed by a processing system including a processor, facilitate performance of operations, the operations comprising:
receiving, from a service design and orchestration (SDO) system, a request to chain a set of universal resource ports, wherein the request is based on the SDO system detecting an order for a service and identifying the set of universal resource ports in accordance with requirements identified in the order, wherein the set of universal resource ports is an abstraction of a corresponding set of network resources in an access network, and wherein the access network is implemented in a service-based architecture configured to provide end-to-end services; and
responsive to the receiving the request to chain the set of universal resource ports, defining a service path from the access network, through a core network, and to an endpoint server device, wherein the service path includes the set of universal resource ports.

12. The non-transitory machine-readable medium of claim 11, wherein the service involves a video-related function, a voice-related function, a security-related function, or a combination thereof.

13. The non-transitory machine-readable medium of claim 11, wherein the request comprises a token associated with an end user device, and wherein the operations further comprise configuring policies for the end user device based on the token.

14. The non-transitory machine-readable medium of claim 11, wherein the corresponding set of network resources comprises physical resources, logical resources, or a combination thereof.

15. The non-transitory machine-readable medium of claim 11, wherein the corresponding set of network resources is abstracted in Layer 2.

16-20. (canceled)

21. A method, comprising:
receiving, by a processing system including a processor, and from a service design and orchestration (SDO) system, a request to chain a set of universal resource ports, wherein the request is based on the SDO system detecting an order for a service and identifying the set of universal resource ports in accordance with requirements identified in the order, wherein the set of universal resource ports is an abstraction of a corresponding set of network resources in an access network, and wherein the access network is implemented in a service-based architecture configured to provide end-to-end services; and
responsive to the receiving the request to chain the set of universal resource ports, defining, by the processing system, a service path from the access network, through a core network, and to an endpoint server device, wherein the service path includes the set of universal resource ports.

22. The method of claim 21, wherein the service involves a video-related function, a voice-related function, a security-related function, or a combination thereof.

23. The method of claim 21, wherein the request comprises a token associated with an end user device, and wherein the method further comprises configuring, by the processing system, policies for the end user device based on the token.

24. The method of claim 21, wherein the corresponding set of network resources comprises physical resources, logical resources, or a combination thereof.

25. The method of claim 21, wherein the corresponding set of network resources is abstracted in Layer 2.
